(19) United States
(12) Patent Application Publication
(10) Pub. No.: US 2026/0126366 A1
(43) Pub. Date: May 7, 2026

(54) DIFFERENTIAL PRESSURE SENSOR AND MONITOR FOR MEASURING FILTER HEALTH

(71) Applicant: Setra Systems LLC, Boxborough, MA (US)

(72) Inventor: Bryce KNUDSON, Lowell, MA (US)

(21) Appl. No.: 19/373,451

(22) Filed: Oct. 29, 2025

Related U.S. Application Data
(60) Provisional application No. 63/715,450, filed on Nov. 1, 2024.

(51) Int. Cl. G01N 15/08; G08B 5/36

(52) U.S. Cl. CPC G01N 15/0826; G08B 5/36; G01N 2015/084

(57) ABSTRACT

Systems, apparatuses, and methods provide for a filter health sensor. The filter health sensor includes a first pressure port and a second pressure port located on a housing and configured to access an upstream side and a downstream side of a filter, respectively. A pressure transducer is configured to measure a differential pressure between the upstream side of the filter and the downstream side of the filter. A color changing indicator is located on a front side of the housing to emit three different colors. A control unit is configured to cause three different colors to emit from the color changing indicator indicating normal filter operations, a warning that the filter should be replaced soon, or a warning that the filter should be replaced immediately.

### FIELD

The instant disclosure relates generally to systems, apparatuses, and methods for filter health sensors. In particular, embodiments of the instant disclosure relate to systems, apparatuses, and methods for a filter health sensor configured to emit three different colors from a color changing indicator indicating differing filter operating conditions.

### BACKGROUND

Customers have many applications where efficiently understanding the health (e.g., how clean or dirty) of the filters in a system is critical to optimal performance. Filter health can affect energy usage, proper air flow, and/or health of the spaces serviced. Current solutions utilize dial indicators or pressure sensors with displays that show the current pressure reading.

These solutions make it difficult to understand the actual health of the system due to their inability to portray the differential pressure limits at which a filter is clean or dirty. Accordingly, there is an unmet need for customers to be able to visually understand the health of the filter in their equipment quickly and accurately.

### SUMMARY

Advantageously, some implementations discussed herein provide a filter health sensor having a first pressure port and a second pressure port located on a housing and configured to access an upstream side and a downstream side of a filter, respectively. The filter health sensor changes a color of the color changing light indicator in response to pressure changes. The filter health sensor may have two pressure thresholds and three light indication colors. The filter health sensor is configured to emit three different colors from the color changing indicator indicating normal filter operations, a warning that the filter should be replaced soon, or a warning that the filter should be replaced immediately.

As will be described in greater detail below, in some implementations discussed herein, systems, apparatuses, and methods provide for a filter health sensor. The filter health sensor includes a first pressure port and a second pressure port located on a housing and configured to access an upstream side and a downstream side of a filter, respectively. A pressure transducer is configured to measure a differential pressure between the upstream side of the filter and the downstream side of the filter. A color changing indicator is located on a front side of the housing to emit three different colors. A control unit is configured to cause three different colors to emit from the color changing indicator indicating normal filter operations, a warning that the filter should be replaced soon, or a warning that the filter should be replaced immediately.

In one example, a filter health sensor comprises a housing, a first pressure port, a second pressure port, a pressure transducer, a color changing indicator, and a control unit. The first pressure port is configured to access an upstream side of a filter. The second pressure port is configured to access a downstream side of the filter. The pressure transducer is located within the housing and is configured to measure a differential pressure between the upstream side of the filter and the downstream side of the filter. The color changing indicator is located on a front side of the housing opposite a back side and is configured to emit three different colors. The control unit is coupled to the pressure transducer and the color changing indicator. The control unit is configured to: cause a first color to emit from the color changing indicator indicating normal filter operating conditions in response to a determination that the measured differential pressure is below both a first threshold value and a second threshold value; cause a second color to emit from the color changing indicator indicating a warning that the filter should be replaced soon in response to a determination that the measured differential pressure is above the first threshold value and below the second threshold value; and cause a third color to emit from the color changing indicator indicating a warning that the filter should be replaced immediately in response to a determination that the measured differential pressure is above the first threshold value and above the second threshold value.

In a further example, a method includes accessing an upstream side of a filter via a first pressure port. A downstream side of the filter is accessed via a second pressure port. A differential pressure is measured between the upstream side of the filter and the downstream side of the filter via a pressure transducer located within the housing. A first color is emitted indicating normal filter operating conditions via a color changing indicator located on a front side of the housing in response to a determination that the measured differential pressure is below both a first threshold value and a second threshold value. A second color is emitted from the color changing indicator indicating a warning that the filter should be replaced soon in response to a determination that the measured differential pressure is above the first threshold value and below the second threshold value. A third color is emitted from the color changing indicator indicating a warning that the filter should be replaced immediately in response to a determination that the measured differential pressure is above the first threshold value and above the second threshold value.

In another example, a filtration-equipped system comprises a filter, a housing, a first pressure port, a second pressure port, a pressure transducer, a color changing indicator, and a control unit. The first pressure port is located on the housing and is configured to access an upstream side of the filter. The second pressure port is located on the housing and is configured to access a downstream side of the filter. The pressure transducer is located within the housing and is configured to measure a differential pressure between the upstream side of the filter and the downstream side of the filter. The color changing indicator is located on a front side of the housing opposite a back side and is configured to emit three different colors. The control unit is coupled to the pressure transducer and the color changing indicator. The control unit is configured to: cause a first color to emit from the color changing indicator indicating normal filter operating conditions in response to a determination that the measured differential pressure is below both a first threshold value and a second threshold value; cause a second color to emit from the color changing indicator indicating a warning that the filter should be replaced soon in response to a determination that the measured differential pressure is above the first threshold value and below the second threshold value; and cause a third color to emit from the color changing indicator indicating a warning that the filter should be replaced immediately in response to a determination that the measured differential pressure is above the first threshold value and above the second threshold value.

This Summary is provided to introduce a selection of concepts in a simplified form that are further described below in the Detailed Description. The foregoing Summary, as well as the following Detailed Description of certain implementations, will be better understood when read in conjunction with the appended drawings. This Summary is not intended to identify key features or essential features of the claimed subject matter, nor is it intended to be used as an aid in determining the scope of the claimed subject matter.

### BRIEF DESCRIPTION OF THE DRAWINGS

The foregoing and other features and advantages will be discussed in detail in the following non-limiting description of specific embodiments in connection with the accompanying drawings, in which:

FIG. 1 illustrates a schematic view of a filtration-equipped system according to an example of the instant disclosure;

FIGS. 2A-2C illustrate a front view a filter health sensor at three different operating conditions according to an example of the instant disclosure;

FIG. 3 is an illustration of a back perspective view of a filter health sensor according to an example of the instant disclosure;

FIG. 4 is an illustration of a side perspective view of a filter health sensor according to an example of the instant disclosure;

FIG. 5 is an illustration of a flowchart of an example method for filter health sensor operations according to an example of the instant disclosure;

FIG. 6 is an illustration of a flowchart of a further example method for filter health sensor operations according to an example of the instant disclosure;

FIG. 7 is a block diagram illustrating a computer program product according to an example of the instant disclosure;

FIG. 8 is a block diagram illustrating an example fluid delivery apparatus according to an example of the instant disclosure; and

FIG. 9 is a block diagram illustrating a hardware apparatus including a semiconductor package according to an example of the instant disclosure.

### DETAILED DESCRIPTION OF THE PRESENT EMBODIMENTS

As will be described in greater detail below, some implementations of the present invention are directed to a filter health sensor comprising a built-in pressure transducer, a microprocessor, a display screen, a color changing light indicator, and an input unit for setting changes. These implementations measure differential pressure between an upstream side of a filter (e.g., some form of a flow barrier) and a downstream side.

In some embodiments, when the pressure reaches a predetermined threshold, the filter health sensor changes the color of the color changing light indicator (e.g., a light ring). The filter health sensor may have two pressure thresholds (also referred to as limits) and three light indication colors. Thresholds may be user defined via the input unit (e.g., in a settings screen on the display screen).

When the pressure is below the first pressure limit, the color changing light indicator (e.g., a light ring) is a first color (e.g., green) giving a visual indication that the filter is in a clean or good state. When the pressure exceeds the first pressure limit (known as “Warning”) the color changing light indicator (e.g., a light ring) turns a second color (e.g., yellow) giving a visual indication that the filter is nearing end of life, is in a dirty state, and/or that the stream is partially obstructed. When the pressure exceeds the second pressure limit (known as “Alarm”) the color changing light indicator (e.g., a light ring) turns a third color (e.g., red) giving a visual indication that the filter is at the end of life, is dirty and needs changed, and/or that the stream is blocked.

Some implementations discussed herein provide an easy-to-understand visual indication of flow barrier status in a market where current products require interpretation and inherent understanding of the barrier properties or a third party system to interpret and present the data.

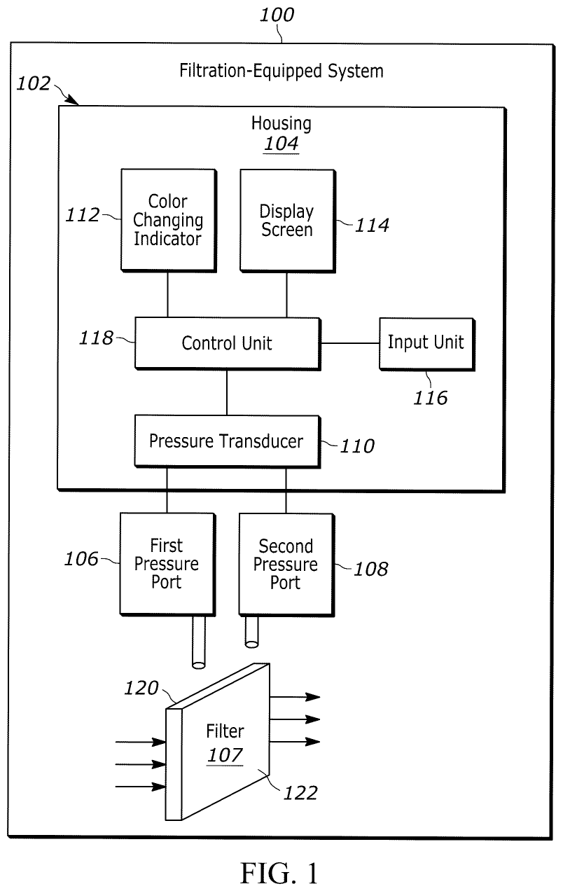

FIG. 1 illustrates a schematic view of a filtration-equipped system 100 according to an example of the instant disclosure. As will be discussed in greater detail below, the filtration-equipped system 100 includes a filter health sensor 102 and a filter 107. In some implementations, the filtration-equipped system 100 may be a heating, ventilation and air-conditioning (HVAC) system. Alternatively, the filtration-equipped system 100 may be used for filter monitoring in commercial air handler units (e.g., especially legacy units using outdated pressure transducers with no connectivity); filter monitoring in air purification equipment; filter monitoring in dust removal equipment in industrial applications; filter monitoring in clean rooms; the like and/or combinations thereof. The filter health sensor 102 includes housing 104, a first pressure port 106, a second pressure port 108, a pressure transducer 110, a color changing indicator 112, a display screen 114 and input unit 116, and a control unit 118.

In some implementations, the housing 104 is sized to fit in a single-gang US electrical box, an international 86 type electrical box (e.g., an 86 mm×86 mm electrical box), or the like.

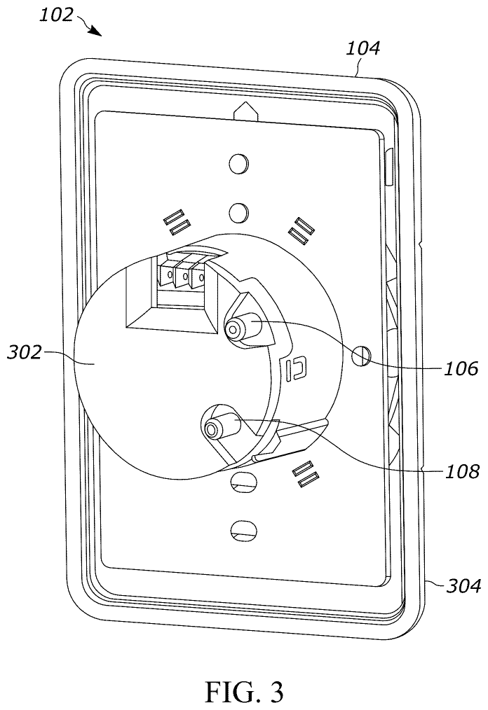

FIG. 3 illustrates a back perspective view of the filter health sensor 102 according to an example of the instant disclosure. As will be discussed in greater detail below, the first pressure port 106 and the second pressure port 108 are located on a back side 302 of the housing 104 (e.g., instead of on a front side 304 of the housing 104).

Referring back to FIG. 1, the first pressure port 106 is configured to access an upstream side 120 of the filter 107. Likewise, the second pressure port 108 is configured to access a downstream side 122 of the filter 107. As used herein, “access” includes fluid communication with the sides 120, 122 of the filter 107 sufficient to enable an assessment of pressure. Further, in some embodiments, tubing or other type of conduit may be used to provide access from the first and second fluid ports 106, 108 and the respective sides 120, 122 of the filter 107.

The pressure transducer 110 is located within the housing 104. Using known components and techniques, the pressure transducer 110 is configured to measure a differential pressure between the upstream side 120 of the filter 107 (e.g., via the first pressure port 106) and the downstream side 122 of the filter 107 (e.g., via the second pressure port 108).

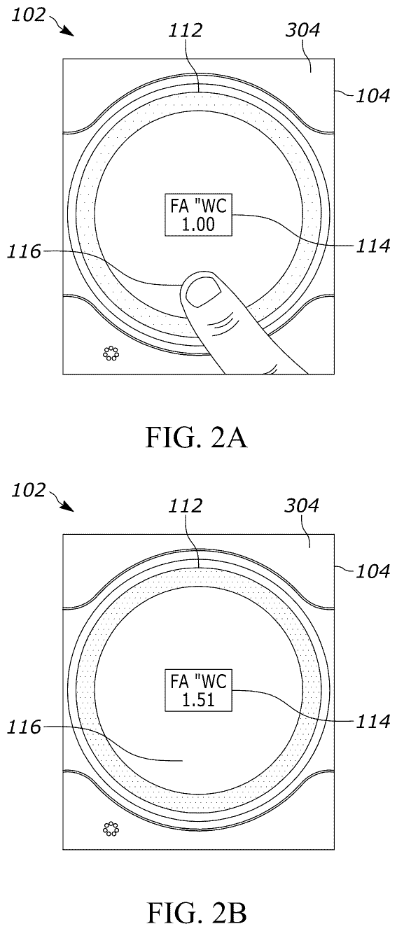

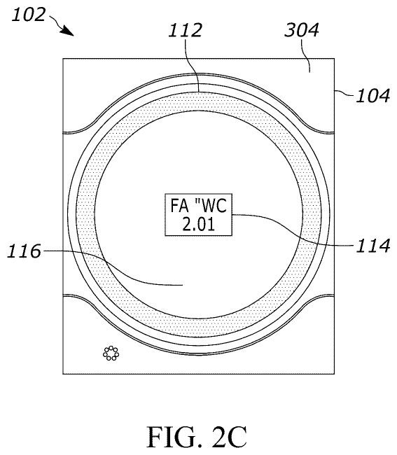

FIGS. 2A-2C illustrate a front view a filter health sensor 102 at three different operating conditions according to an example of the instant disclosure. As illustrated, the color changing indicator 112 is located on the front side 304 of the housing 104 opposite the back side 302 (e.g., see FIG. 3). The color changing indicator 112, which may comprise one or more lights sources (e.g., light emitting diodes (LEDs), is configured to emit three different colors. In some implementations, the first color is green (e.g., as illustrated in FIG. 2A), the second color is yellow (e.g., as illustrated in FIG. 2B), and the third color is red (e.g., as illustrated in FIG. 2C), although different color combinations may be utilized. In some examples, the color changing indicator 112 may be implemented as a color changing light ring (e.g., or other geometric shape). The color changing indicator 112 extends from the front side 304 of the housing 104 so as to transmit light in 180 degrees with respect to the front side 304 of the housing 104.

The display screen 114, such as a liquid crystal display (LCD) screen, is located on the front side 304 of the housing 104. In some implementations, the display screen 114 is located within the color changing light ring 112. The display screen 114 is configured to display the measured differential pressure (e.g., shown here as 1.00 “WC (inches of water column pressure) (e.g., as illustrated in FIGS. 2A), 1.51 “WC (e.g., as illustrated in FIG. 2B), and 2.01 “WC (e.g., as illustrated in FIG. 2C) in various operating conditions.

The input unit 116 is located on the front side 304 of the housing 104. In some implementations, the input unit 116 is located within the color changing light ring 112. In some examples, the input unit 116 is implemented as a touch sensor, buttons, the like, and/or combinations thereof. The input unit 116 may be utilized by a user to input first and second threshold values to govern the operation of the control unit 118.

Referring back to FIG. 1, the control unit 118 is coupled to the pressure transducer 110, the color changing indicator 112, the display screen 114, and the input unit 116. In some implementations, the control unit 118 may be a microprocessor.

In operation, the control unit is configured to receive the first and second threshold values from user input to the input unit 116. The control unit 118 is configured to cause a first color (e.g., green) to emit from the color changing indicator 112 indicating normal filter operating conditions in response to a determination that the measured differential pressure is below both a first threshold value and a second threshold value (e.g., to indicate normal operating conditions). The control unit 118 is configured to cause a second color (e.g., yellow) to emit from the color changing indicator 112 indicating a warning that the filter should be replaced soon in response to a determination that the measured differential pressure is above the first threshold value and below the second threshold value (e.g., to indicate impaired operating conditions, such as: that the filter is nearing end of life, is in a dirty state, and/or that the stream is partially obstructed). The control unit 118 is configured to cause a third color (e.g., red) to emit from the color changing indicator 112 indicating a warning that the filter should be replaced immediately in response to a determination that the measured differential pressure is above the first threshold value and above the second threshold value (e.g., to indicate critical operating conditions, such as: the filter is at the end of life, is dirty and needs changed, and/or that the stream is blocked). It is appreciated that other types of indicators may used in addition to the color changing indicator, e.g., audible alarms or flashing of the color changing indicator.

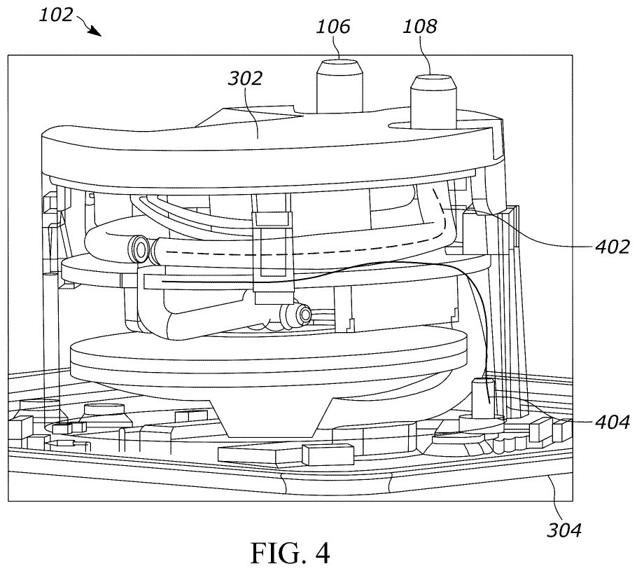

As illustrated in FIGS. 3 and 4, a difference from some existing products is moving the second pressure port 108 (e.g., a down-stream pressure port) from the front side 304 of the housing 104 to the back side 302 of the housing 104. This provides two pressure ports for connecting flow paths from upstream and downstream of the filter barrier enabling proper measurement of differential pressure change across the filter barrier and determination of filter health.

As illustrated in FIG. 4, a new internal path 402 for the second pressure port 108 (e.g., a down-stream pressure port) to the back side 302 of the housing 104 is illustrated as compared to a prior internal path 404 for the second pressure port 108 (e.g., a down-stream pressure port) to the front side 304 of the housing 104.

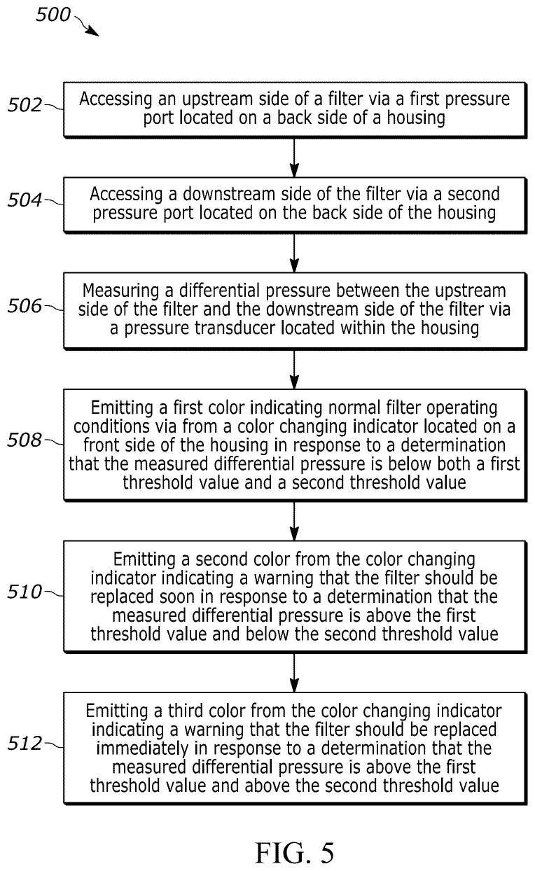

FIG. 5 is a flowchart of another example of a method 500 for filter health sensor operations according to an example. The method 500 may generally be implemented in an apparatus, such as, for example, the filter health sensor 102 (FIG. 1), already discussed.

In an example, the method 500 (as well as method 600) can be implemented in computer readable instructions (e.g., software), configurable computer readable instructions (e.g., firmware), fixed-functionality computer readable instructions (e.g., hardware), etc., or any combination thereof.

Illustrated processing block 502 provides for accessing an upstream side of a filter. For example, an upstream side of a filter may be accessed via a first pressure port located on a back side of a housing.

Illustrated processing block 504 provides for accessing a downstream side of the filter. For example, a downstream side of the filter may be accessed via a second pressure port located on the back side of the housing.

Illustrated processing block 506 provides for measuring a differential pressure between the upstream side of the filter and the downstream side of the filter via a pressure transducer located within the housing.

Illustrated processing block 508 provides for emitting a first color from the color changing indicator. For example, a first color may be emitted indicating normal filter operating conditions via a color changing indicator located on a front side of the housing in response to a determination that the measured differential pressure is below both a first threshold value and a second threshold value.

Illustrated processing block 510 provides for emitting a second color from the color changing indicator. For example, a second color may be emitted from the color changing indicator indicating a warning that the filter should be replaced soon in response to a determination that the measured differential pressure is above the first threshold value and below the second threshold value.

Illustrated processing block 512 provides for emitting a third color from the color changing indicator. For example, a third color may be emitted from the color changing indicator indicating a warning that the filter should be replaced immediately in response to a determination that the measured differential pressure is above the first threshold value and above the second threshold value.

In some implementations, the first color is green, the second color is yellow, and the third color is red.

In some examples, the determination as to whether the measured differential pressure is above the first threshold value and above the second threshold value is performed via a microprocessor.

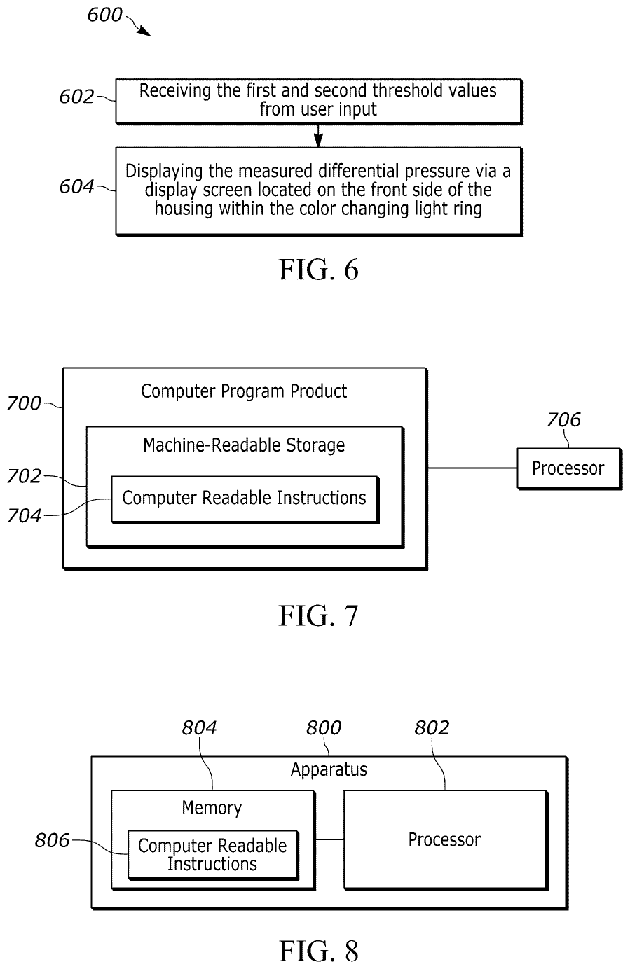

FIG. 6 is a flowchart of another example of a method 600 for filter health sensor operations according to an example. The method 600 may generally be implemented in an apparatus, such as, for example, the filter health sensor 102 (FIG. 1), already discussed.

Illustrated processing block 602 provides for receiving the first and second threshold values. For example, the first and second threshold values may be received from user input via the input unit.

Illustrated processing block 604 provides for displaying the measured differential pressure. For example, the measured differential pressure may be displayed via a display screen located on the front side of the housing within the color changing light ring.

FIG. 7 illustrates a block diagram of an example computer program product 700. In some examples, as shown in FIG. 7, computer program product 700 includes a machine-readable storage 702 that can also include computer readable instructions 704. In some implementations, the machine-readable storage 702 can be implemented as a non-transitory machine-readable storage. In some implementations the computer readable instructions 704, which can be implemented as software, for example. In an example, the computer readable instructions 704, when executed by a processor 706, implement one or more aspects of method 500 (FIG. 5) and/or method 600 (FIG. 6), already discussed.

FIG. 8 shows an illustrative example of an apparatus 800. In the illustrated example, the apparatus 800 can include a processor 802 and a memory 804 communicatively coupled to the processor 802. The memory 804 can include computer readable instructions 806, which can be implemented as software, for example. In an example, the computer readable instructions 806, when executed by the processor 802, implement one or more aspects of the method 500 (FIG. 5) and/or method 600 (FIG. 6), already discussed.

In some implementations, the processor 802 can include a general purpose controller, a special purpose controller, a storage controller, a storage manager, a memory controller, a micro-controller, a general purpose processor, a special purpose processor, a central processor unit (CPU), the like, and/or combinations thereof.

Further, implementations can include distributed processing, component/object distributed processing, parallel processing, the like, and/or combinations thereof. For example, virtual computer system processing can implement one or more of the methods or functionalities as described herein, and the processor 802 described herein can be used to support such virtual processing.

In some examples, the memory 804 is an example of a computer-readable storage medium. For example, memory 804 can be any memory which is accessible to the processor 802, including, but not limited to RAM memory, registers, and register files, the like, and/or combinations thereof. References to “computer memory” or “memory” should be interpreted as possibly being multiple memories. The memory can for instance be multiple memories within the same computer system. The memory can also be multiple memories distributed amongst multiple computer systems or computing devices.

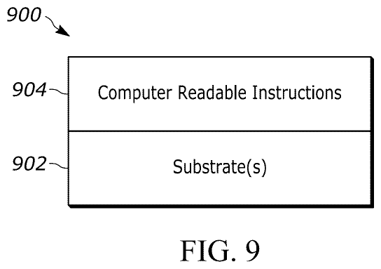

FIG. 9 shows an illustrative semiconductor apparatus 900 (e.g., chip and/or package). The illustrated apparatus 900 includes one or more substrates 902 (e.g., silicon, sapphire, or gallium arsenide) and computer readable instructions 904 (such as, configurable computer readable instructions (e.g., firmware) and/or fixed-functionality computer readable instructions (e.g., hardware)) coupled to the substrate(s) 902. In an example, the computer readable instructions 904 implement one or more aspects of the method 500 (FIG. 5) and/or method 600 (FIG. 6), already discussed.

In some implementations, computer readable instructions 904 can include transistor array and/or other integrated circuit (IC) components. For example, configurable firmware logic and/or fixed-functionality hardware logic implementations of the computer readable instructions 904 can include configurable computer readable instructions such as, for example, programmable logic arrays (PLAs), field programmable gate arrays (FPGAs), complex programmable logic devices (CPLDs), or fixed-functionality computer readable instructions (e.g., hardware) using circuit technology such as, for example, application specific integrated circuit (ASIC), complementary metal oxide semiconductor (CMOS) or transistor-transistor logic (TTL) technology, the like, and/or combinations thereof.

Additional Notes and Examples:
Clause 1 is a filter health sensor, comprising: a housing; a first pressure port located on the housing, the first pressure port configured to access an upstream side of a filter; a second pressure port located on the housing, the second pressure port configured to access a downstream side of the filter; a pressure transducer located within the housing, the pressure transducer configured to measure a differential pressure between the upstream side of the filter and the downstream side of the filter; a color changing indicator located on a front side of the housing opposite a back side, the color changing indicator configured to emit three different colors; and a control unit coupled to the pressure transducer and the color changing indicator, the control unit configured to: cause a first color to emit from the color changing indicator indicating normal filter operating conditions in response to a determination that the measured differential pressure is below both a first threshold value and a second threshold value; cause a second color to emit from the color changing indicator indicating a warning that the filter should be replaced soon in response to a determination that the measured differential pressure is above the first threshold value and below the second threshold value; and cause a third color to emit from the color changing indicator indicating a warning that the filter should be replaced immediately in response to a determination that the measured differential pressure is above the first threshold value and above the second threshold value.
Clause 2 includes the filter health sensor of Clause 1, wherein the first color is green, wherein the second color is yellow, and wherein the third color is red.
Clause 3 includes the filter health sensor of any one of Clauses 1 to 2, wherein the color changing indicator is a color changing light ring.
Clause 4 includes the filter health sensor of Clause 3, further comprising a display screen located on the front side of the housing within the color changing light ring, the display screen configured to display the measured differential pressure.
Clause 5 includes the filter health sensor of any one of Clauses 1 to 4, wherein the control unit is a microprocessor.
Clause 6 includes the filter health sensor of any one of Clauses 1 to 5, wherein the control unit is further configured to receive the first and second threshold values from user input.
Clause 7 is a method comprising: accessing an upstream side of a filter via a first pressure port located on a housing; accessing a downstream side of the filter via a second pressure port located on the housing; measuring a differential pressure between the upstream side of the filter and the downstream side of the filter via a pressure transducer located within the housing; emitting a first color indicating normal filter operating conditions via a color changing indicator located on a front side of the housing in response to a determination that the measured differential pressure is below both a first threshold value and a second threshold value; emitting a second color from the color changing indicator indicating a warning that the filter should be replaced soon in response to a determination that the measured differential pressure is above the first threshold value and below the second threshold value; and emitting a third color from the color changing indicator indicating a warning that the filter should be replaced immediately in response to a determination that the measured differential pressure is above the first threshold value and above the second threshold value.
Clause 8 includes the method of Clause 7, wherein the first color is green, wherein the second color is yellow, and wherein the third color is red.
Clause 9 includes the method of any one of Clauses 7 to 8, wherein the color changing indicator is a color changing light ring.
Clause 10 includes the method of Clause 9, further comprising: displaying the measured differential pressure via a display screen located on the front side of the housing within the color changing light ring.
Clause 11 includes the method of any one of Clauses 7 to 10, wherein the determination as to whether the measured differential pressure is above the first threshold value and above the second threshold value is performed via a microprocessor.
Clause 12 includes the method of any one of Clauses 7 to 11, further comprising: receiving the first and second threshold values from user input.
Clause 13 is a filtration-equipped system, comprising: a filter; a housing; a first pressure port located on the housing, the first pressure port configured to access an upstream side of the filter; a second pressure port located on the housing, the second pressure port configured to access a downstream side of the filter; a pressure transducer located within the housing, the pressure transducer configured to measure a differential pressure between the upstream side of the filter and the downstream side of the filter; a color changing indicator located on a front side of the housing opposite a back side, the color changing indicator configured to emit three different colors; and a control unit coupled to the pressure transducer and the color changing indicator, the control unit configured to: cause a first color to emit from the color changing indicator indicating normal filter operating conditions in response to a determination that the measured differential pressure is below both a first threshold value and a second threshold value; cause a second color to emit from the color changing indicator indicating a warning that the filter should be replaced soon in response to a determination that the measured differential pressure is above the first threshold value and below the second threshold value; and cause a third color to emit from the color changing indicator indicating a warning that the filter should be replaced immediately in response to a determination that the measured differential pressure is above the first threshold value and above the second threshold value.
Clause 14 includes the filtration-equipped system of Clause 13, wherein the first color is green, wherein the second color is yellow, and wherein the third color is red.
Clause 15 includes the filtration-equipped system of any one of Clauses 13 to 14, wherein the color changing indicator is a color changing light ring.
Clause 16 includes the filtration-equipped system of Clause 15, further comprising a display screen located on the front side of the housing within the color changing light ring, the display screen configured to display the measured differential pressure.
Clause 17 includes the filtration-equipped system of any one of Clauses 13 to 16, wherein the control unit is a microprocessor.
Clause 18 includes the filtration-equipped system of any one of Clauses 13 to 17, wherein the control unit is further configured to receive the first and second threshold values from user input.
Clause 19 includes the filtration-equipped system of any one of Clauses 13 to 18, wherein the filtration-equipped system comprises a heating, ventilation and air-conditioning (HVAC) system.
Clause 20 includes a machine-readable storage including machine-readable instructions, which when executed, implement a method or realize an apparatus as claimed in any preceding Clause.
Clause 21 includes an apparatus including means for performing the function of any preceding Clause.

All definitions, as defined and used herein, should be understood to control over dictionary definitions, definitions in documents incorporated by reference, and/or ordinary meanings of the defined terms.

Furthermore, for ease of understanding, certain functional blocks can have been delineated as separate blocks; however, these separately delineated blocks should not necessarily be construed as being in the order in which they are discussed or otherwise presented herein. For example, some blocks can be able to be performed in an alternative ordering, simultaneously, etc.

As used herein, phrases substantially similar to “at least one of A, B or C” are intended to be interpreted in the disjunctive, i.e., to require A or B or C or any combination thereof unless stated or implied by context otherwise. Further, phrases substantially similar to “at least one of A, B and C” are intended to be interpreted in the conjunctive, i.e., to require at least one of A, at least one of B and at least one of C unless stated or implied by context otherwise. Further still, the term “substantially” or similar words requiring subjective comparison are intended to mean “within manufacturing tolerances” unless stated or implied by context otherwise.

As used herein, the terms “coupled,” “attached,” “connected,” or “operatively connected” can be used herein to refer to any type of relationship, direct or indirect, between the components in question. For example, the terms “coupled,” “attached,” “connected,” or “operatively connected” may refer to at least a functional relationship between two elements and may encompass configurations in which the two elements are directed connected to each other, i.e., without any intervening elements, or indirectly connected to each other, i.e., with intervening elements. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action can occur, either in a direct or indirect manner.

Although a number of illustrative examples are described herein, it should be understood that numerous other modifications and examples can be devised by those skilled in the art that will fall within the spirit and scope of the principles of the foregoing disclosure. More particularly, reasonable variations and modifications are possible in the component parts and/or arrangements of the subject combination arrangement within the scope of the foregoing disclosure, the drawings and the appended claims without departing from the spirit of the foregoing disclosure. In addition to variations and modifications in the component parts and/or arrangements, alternative uses will also be apparent to those skilled in the art. The examples can be combined to form additional examples.

What is claimed is:

1. A filter health sensor, comprising:
a housing;
a first pressure port located on the housing, the first pressure port configured to access an upstream side of a filter;
a second pressure port located on the housing, the second pressure port configured to access a downstream side of the filter;
a pressure transducer located within the housing, the pressure transducer configured to measure a differential pressure between the upstream side of the filter and the downstream side of the filter;
a color changing indicator located on a front side of the housing opposite a back side of the housing, the color changing indicator configured to emit three different colors; and
a control unit coupled to the pressure transducer and the color changing indicator, the control unit configured to:
cause a first color to emit from the color changing indicator indicating normal filter operating conditions in response to a determination that the measured differential pressure is below both a first threshold value and a second threshold value;
cause a second color to emit from the color changing indicator indicating a warning that the filter should be replaced soon in response to a determination that the measured differential pressure is above the first threshold value and below the second threshold value; and
cause a third color to emit from the color changing indicator indicating a warning that the filter should be replaced immediately in response to a determination that the measured differential pressure is above the first threshold value and above the second threshold value.

2. The filter health sensor of claim 1, wherein the first color is green, wherein the second color is yellow, and wherein the third color is red.

3. The filter health sensor of claim 1, wherein the color changing indicator is a color changing light ring.

4. The filter health sensor of claim 3, further comprising a display screen located on the front side of the housing within the color changing light ring, the display screen configured to display the measured differential pressure.

5. The filter health sensor of claim 1, wherein the control unit is a microprocessor.

6. The filter health sensor of claim 1, wherein the control unit is further configured to receive the first and second threshold values from user input.

7. A method comprising:
accessing an upstream side of a filter via a first pressure port located on a housing;
accessing a downstream side of the filter via a second pressure port located on the housing;
measuring a differential pressure between the upstream side of the filter and the downstream side of the filter via a pressure transducer located within the housing;
emitting a first color indicating normal filter operating conditions via a color changing indicator located on a front side of the housing in response to a determination that the measured differential pressure is below both a first threshold value and a second threshold value;
emitting a second color from the color changing indicator indicating a warning that the filter should be replaced soon in response to a determination that the measured differential pressure is above the first threshold value and below the second threshold value; and
emitting a third color from the color changing indicator indicating a warning that the filter should be replaced immediately in response to a determination that the measured differential pressure is above the first threshold value and above the second threshold value.

8. The method of claim 7, wherein the first color is green, wherein the second color is yellow, and wherein the third color is red.

9. The method of claim 7, wherein the color changing indicator is a color changing light ring.

10. The method of claim 9, further comprising: displaying the measured differential pressure via a display screen located on the front side of the housing within the color changing light ring.

11. The method of claim 7, wherein the determination as to whether the measured differential pressure is above the first threshold value and above the second threshold value is performed via a microprocessor.

12. The method of claim 7, further comprising: receiving the first and second threshold values from user input.

13. A filtration-equipped system, comprising:
a filter;
a housing;
a first pressure port located on the housing, the first pressure port configured to access an upstream side of the filter;
a second pressure port located on the housing, the second pressure port configured to access a downstream side of the filter;
a pressure transducer located within the housing, the pressure transducer configured to measure a differential pressure between the upstream side of the filter and the downstream side of the filter;
a color changing indicator located on a front side of the housing opposite a back side of the housing, the color changing indicator configured to emit three different colors; and
a control unit coupled to the pressure transducer and the color changing indicator, the control unit configured to:
cause a first color to emit from the color changing indicator indicating normal filter operating conditions in response to a determination that the measured differential pressure is below both a first threshold value and a second threshold value;
cause a second color to emit from the color changing indicator indicating a warning that the filter should be replaced soon in response to a determination that the measured differential pressure is above the first threshold value and below the second threshold value; and
cause a third color to emit from the color changing indicator indicating a warning that the filter should be replaced immediately in response to a determination that the measured differential pressure is above the first threshold value and above the second threshold value.

14. The filtration-equipped system of claim 13, wherein the first color is green, wherein the second color is yellow, and wherein the third color is red.

15. The filtration-equipped system of claim 13, wherein the color changing indicator is a color changing light ring.

16. The filtration-equipped system of claim 15, further comprising a display screen located on the front side of the housing within the color changing light ring, the display screen configured to display the measured differential pressure.

17. The filtration-equipped system of claim 13, wherein the control unit is a microprocessor.

18. The filtration-equipped system of claim 13, wherein the control unit is further configured to receive the first and second threshold values from user input.

19. The filtration-equipped system of claim 13, wherein the filtration-equipped system comprises a heating, ventilation and air-conditioning (HVAC) system.
